(19) United States
(12) Patent Application Publication
(10) Pub. No.: US 2026/0125043 A1
(43) Pub. Date: May 7, 2026

(54) CONTROL APPARATUS FOR VEHICLES

(71) Applicant: DENSO CORPORATION, Kariya-city (JP)

(72) Inventors: Mitsuharu HIGASHITANI, Kariya-city (JP); Noriaki Ikemoto, Kariya-city (JP)

(73) Assignee: DENSO CORPORATION, Kariya-city (JP)

(21) Appl. No.: 19/375,510

(22) Filed: Oct. 31, 2025

(30) Foreign Application Priority Data
Nov. 6, 2024 (JP) 2024-194470

(51) Int. Cl. B60W 20/12; B60W 30/095; B60W 30/14; B60W 30/16

(52) U.S. Cl. CPC B60W 20/12; B60W 30/0956; B60W 30/146; B60W 30/16; B60W 2552/05; B60W 2552/30; B60W 2554/802; B60W 2555/60

(57) ABSTRACT

In a control apparatus configured to control a control target included in a vehicle in accordance with a predetermined travel plan of the vehicle, control circuitry is configured to cause the control apparatus to: (I) Determine a command parameter that controls the control target such that the control target operates in accordance with the travel plan, (II) Execute, independently from the travel plan, independent control that determines an acceptable condition that defines an acceptable range of the control parameter, and (III) Change, in response to determination that the command parameter determined by the control circuitry conflicts with the acceptable condition, the command parameter so as to satisfy the acceptable condition.

### CROSS-REFERENCE TO RELATED APPLICATION

This present application is based on and claims the benefit of priority from Japanese Patent Application No. 2024-194470 filed on November 6, 2024, the disclosure of which is incorporated herein by reference.

### TECHNICAL FIELD

The present disclosure relates to control apparatuses for automatically controlling a control target included in a vehicle.

### BACKGROUND

Japanese Patent Publication No. 4952268 discloses a travel control plan generation device. This travel control plan generation device is a vehicle control apparatus capable of generating a travel control plan (hereinafter also referred to as a “travel plan”) that enables the vehicle to automatically travel in a manner reflecting the driver’s driving preferences.

Specifically, the travel control plan generation device receives, via a priority input unit, the priority level of each of the driver’s driving preferences, and sets, in a parameter value setting unit, values of travel control plan generation parameters according to the input priorities. Then, the travel plan generation device genets, based on the travel control plan generation parameters reflecting the driver’s driving preferences, a travel plan in a plan generation unit.

### SUMMARY

The travel control plan generation device disclosed in the patent publication generates a travel plan as set forth above. When the amount of information required for generating the travel plan is small, the travel plan can be generated by a control apparatus installed in the vehicle, without utilizing external computational resources.

However, in recent years, as the market introduction of electric vehicles and the like has accelerated, there has been an increasing demand for long-term travel plans from the viewpoint of energy management.

In such a case, because the travel plan is a long-term plan, an enormous amount of computation is required to generate the travel plan. Therefore, there is a trend toward placing computational resources for generating the travel plan outside the vehicle, such as in a cloud environment. Consequently, it becomes necessary to appropriately coordinate the function for generating and executing the travel plan with other functions, such as safety systems, which are given higher priority than the execution of the travel plan.

As a result of detailed studies conducted by the inventors, the above circumstances have been found.

In view of the above circumstances, the present disclosure seems to provide control apparatuses, each of which is capable of appropriately coordinating, while executing a determined travel plan, (i) independent control prior to the travel plan and (ii) the travel plan.

An exemplary aspect of the present disclosure provides a control apparatus configured to control a control target included in a vehicle in accordance with a predetermined travel plan of the vehicle. The control apparatus includes control circuitry configured to cause the control apparatus to determine a command parameter that controls the control target such that the control target operates in accordance with the travel plan. The control circuitry configured to cause the control apparatus to execute, independently from the travel plan, independent control that determines an acceptable condition that defines an acceptable range of the control parameter. The control circuitry configured to cause the control apparatus to change, in response to determination that the command parameter determined by the control circuitry conflicts with the acceptable condition, the command parameter so as to satisfy the acceptable condition.

The above configuration of the control apparatus makes it possible to, when the command parameter determined to control the control target such that the control target operates in accordance with the travel plan conflicts with the acceptable condition determined by the independent control, give higher priority to the independent control than the travel plan. Accordingly, the above configuration of the control apparatus properly coordinates the independent control, which has higher priority, and the travel plan while executing the travel plan.

Where reference characters are used in parentheses for various elements throughout the present disclosure, such characters are provided merely as an example of the correspondence between the elements and the specific structures in the embodiments described later. The present disclosure is therefore not limited by the use of such reference characters.

### BRIEF DESCRIPTION OF THE DRAWINGS

Other aspects of the present disclosure will become apparent from the following description of embodiments with reference to the accompanying drawings in which:

FIG. 1 is a side view schematically illustrating a vehicle according to the first embodiment;

FIG. 2 is a block diagram schematically illustrating typical components installed in the vehicle illustrated in FIG. 1 and typical components of a cloud that is communicably connected to the vehicle according to the first embodiment;

FIG. 3 is a timing chart illustrating a combination of graphs, each of which schematically shows an example of a transition of a corresponding one of a target vehicle speed, a target battery temperature, a target cabin temperature, and a predicted charge rate of a high-voltage battery included in a travel plan determined prior to the vehicle’s start of traveling;

FIG. 4 is a flowchart schematically illustrating a control routine for preparing and executing a travel plan of the vehicle, which includes a scheduled travel route of the vehicle according to the first embodiment;

FIG. 5 is a schematic view illustrating a scheduled travel route included in the travel plan according to the first embodiment;

FIG. 6 is a flowchart schematically illustrating a control routine to be executed by an in-vehicle computer according to the first embodiment;

FIG. 7 is a functional block diagram schematically illustrating functional components included in the in-vehicle computer according to the first embodiment;

FIG. 8 is a flowchart schematically illustrating a control routine for preparing and executing a travel plan of the vehicle according to the second embodiment, which corresponds to the control routine illustrated in FIG. 4;

FIG. 9 is a flowchart schematically illustrating a control routine for preparing and executing a travel plan of the vehicle according to the third embodiment, which corresponds to the control routine illustrated in FIG. 4;

FIG. 10 is a flowchart schematically illustrating a control routine for preparing and executing a travel plan of the vehicle according to the fourth embodiment, which corresponds to the control routine illustrated in FIG. 4;

FIG. 11 is a flowchart schematically illustrating a control routine for preparing and executing a travel plan of the vehicle according to a modification of the fourth embodiment, which corresponds to the control routine illustrated in FIG. 4;

FIG. 12 is a flowchart schematically illustrating a control routine for preparing and executing a travel plan of the vehicle according to the fifth embodiment, which corresponds to the control routine illustrated in FIG. 4;

FIG. 13 is a part of a flowchart representing step S207a with which step S207 of FIG. 9 is replaced; and

FIG. 14 is a part of a flowchart representing step S306a with which step S306 of FIG. 9 is replaced.

### DETAILED DESCRIPTION OF EMBODIMENTS

The following describes exemplary embodiments of the present disclosure with reference to accompanying drawings. In the following exemplary embodiments, substantially identical or equivalent components are represented by the same reference characters and redundant explanations are omitted.

### FIRST EMBODIMENT

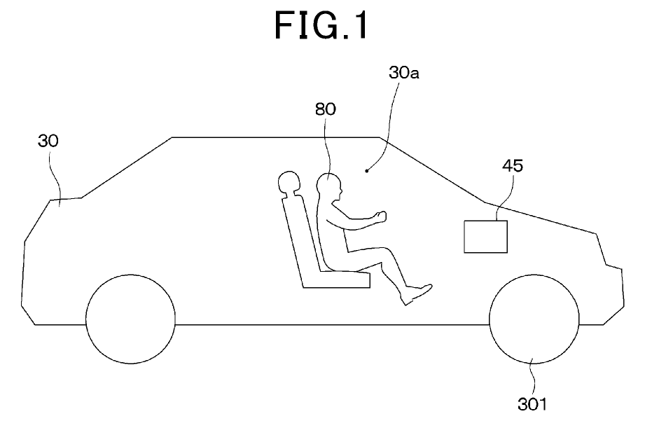

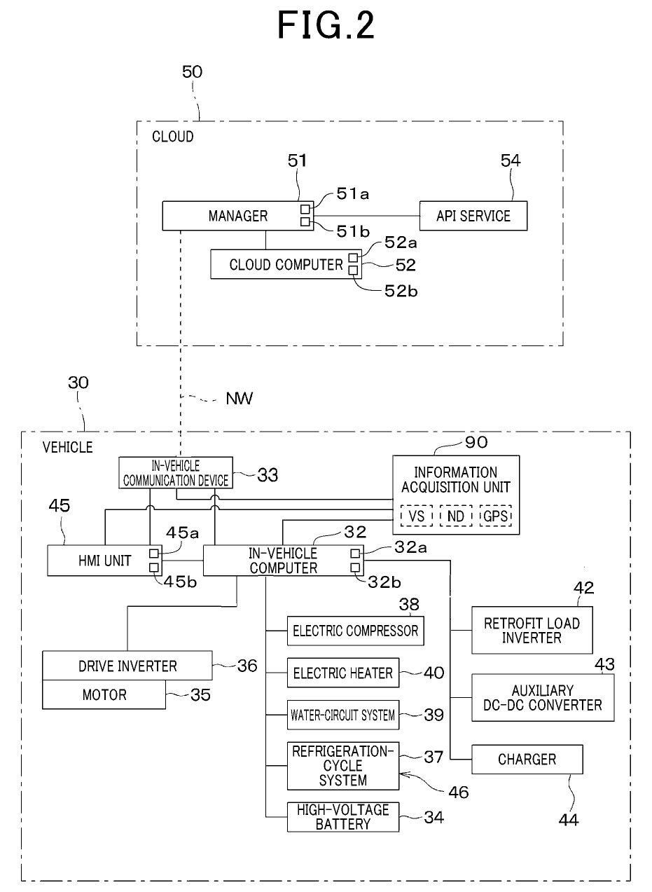

A vehicle 30 illustrated in FIGS. 1 and 2 is, for example, an electric vehicle. The electric vehicle as the vehicle 30 according to the first embodiment will also be referred to as a Battery Electric vehicle (BEV), and the vehicle (BEV) 30 does not include an engine, and includes a high-voltage battery, i.e., a secondary battery, 34, and can travel based on power obtained from the high-voltage battery 34.

As illustrated in FIG. 2, the vehicle 30 according to the first embodiment includes an in-vehicle computer 32, a communication device 33, the high-voltage battery 34, a motor 35, a drive inverter 36, a refrigeration-cycle system 37, an electric compressor 38, a water-circuit system 39, and an electric heater 40. Additionally, the vehicle 30 includes a retrofit load inverter 42, an auxiliary DC (direct current)-DC converter 43, a charger 44, and an HMI (Human Machine Interface) 45.

The in-vehicle communication device 33 is configured to cause plural components connected thereto via wired or wireless connection to communicate information with one another. For example, in the vehicle 30, the in-vehicle computer 32 is communicably connected to the in-vehicle communication device 33, and the HMI unit 45 is communicably connected to the in-vehicle communication device 33.

The vehicle 50 of the first embodiment is connected to be wirelessly communicable with the cloud 50 located outside the vehicle 30. Specifically, the in-vehicle communication device 33 of the vehicle 30 and the manager 51 of the cloud 50 are wirelessly connected to each other through a wireless network NW. The wireless network NW includes, for example, a wireless communication line of 4G or 5G and the Internet. The manager 51 is communicably connected to a cloud computer 52 included in the cloud 50. This enables each component of the vehicle 30 to communicate information with the manager 51 and the in-vehicle computer 52 of the cloud 50.

The cloud, i.e., cloud server, 50 refers to, for example, an external information processing environment that is communicably connected to the vehicle 30 via the wireless network NW. The cloud 50 may be implemented as a physical server, a group of servers, a virtualized environment, or any combination thereof, provided that the functions described herein are realized.

The in-vehicle computer 32, the manager 51, and the cloud computer 52 each have a configuration as a microcomputer provided with a CPU 32a, 51a, 52a and a storage 32b, 51b, 52b including, for example, a RAM, a ROM, and a non-volatile rewritable memory. Each of the in-vehicle computer 32, the manager 51, and the cloud computer 52 reads and executes computer programs, i.e., computer-program instructions, stored in the corresponding ROM or the non-volatile rewritable memory. Each of the ROM and the non-volatile rewritable memory serves as a non-transitory tangible storage medium. Executing the computer programs enables methods corresponding to the computer programs to be carried out.

That is, each of the in-vehicle computer 32, the manager 51, and the cloud computer 52 executes various control routinees in accordance with the corresponding computer programs.

The in-vehicle computer 32 corresponds to, for example, a control apparatus installed in the vehicle 30. Because the vehicle 30 is connected to be wirelessly communicable with the could 50, each of the manager 51 and the cloud computer 52 corresponds to, for example, an external computer located outside the vehicle 30 and connected to be wirelessly communicable with the vehicle 30.

Each of the in-vehicle computer 32, the manager 51, and the cloud computer 52 is capable of executing control routines independently. Additionally, because the in-vehicle computer 32, the manager 51, and the cloud computer 52 are capable of information communication with one another, the in-vehicle computer 32, the manager 51, and the cloud computer 52 are capable of cooperating with each other to execute one control routine as if they were a single computer.

The high-voltage battery 34 is a rechargeable secondary battery, and is constituted by, for example, a lithium ion battery or a nickel-hydrogen battery or a nickel-metal-hydride battery. The high-voltage battery 34 serves as a vehicle power supply that supplies current to each of the electric devices, which include the drive inverter 36, installed in the vehicle 30.

The motor 35 is a traction motor that rotationally drives wheels, i.e., driving wheels 301, of the vehicle 30. That is, the motor 35 serves as a power source for vehicle propulsion. Specifically, the motor 35 is configured to receive electric power supplied from the drive inverter 36 to accordingly rotate the driving wheels 301 of the vehicle 30, thus propelling the vehicle 30. The drive inverter 36 is configured to convert a direct current from the high-voltage battery 34 into an alternating current, and supply the converted alternating current to the motor 35, thus rotating the motor 35.

Additionally, when decelerating or braking the vehicle 30, the motor 35 is configured to generate power to accordingly generate braking torque that decelerates the vehicle 30. The power generated by the motor 35 is supplied to the high-voltage battery 34 via the drive inverter 36, thus charging the high-voltage battery 34.

The refrigeration cycle system 37 includes, for example, a plurality of heat exchangers, an expansion valve, a flow path switching valve. The refrigeration cycle system 37 and the electric compressor 38 constitute a refrigeration cycle circuit in which a refrigerant is circulated. In the refrigeration cycle circuit, circulation of the refrigerant enables a vapor compression refrigeration cycle to be executed. Execution of the refrigeration cycle enables temperature adjustment of the high-voltage battery 34, the motor 35, and the drive inverter 36, and air conditioning in the cabin 30a to be carried out.

The electric compressor 38 is configured to operate based on power supplied from the high-voltage battery 34 to draw in the refrigerant in the refrigeration cycle circuit, compress the refrigerant, and then discharge the compressed refrigerant. That is, the refrigerant is circulated in the refrigeration cycle circuit based on operation of the electric compressor 38, and the circulation of the refrigerant enables heat to be transferred from one of the plurality of heat exchangers to another based on the circulation of the refrigerant.

The water circuit system 39 includes a pump and one or more heat exchangers that constitute a water circuit in which a liquid medium such as cooling water is circulated. For example, at least one of the heat exchangers provided across both the water circuit and the refrigeration cycle circuit causes liquid medium in the water circuit to exchange heat with the refrigerant in the refrigeration cycle circuit. That is, the water circuit cooperates with the refrigeration cycle circuit to perform both (i) temperature adjustment of each of the thermal-management target devices connected to the water circuit, such as the high-voltage battery 34, the motor 35, and the drive inverter 36 and (ii) air conditioning in the vehicle cabin 30a.

The electric heater 40 is disposed, for example, in a cabin air-conditioning unit, and is configured to generate heat based on power supplied from the high-voltage battery 34. Specifically, the electric heater 40 is configured to heat air, which is to be blown out from the cabin air-conditioning unit to the cabin 30a, within the cabin air-conditioning unit.

As described above, the refrigeration cycle system 37, the electric compressor 38, the water circuit system 39, and the electric heater 40 as a whole perform air conditioning in the cabin 30a, temperature adjustment of the high-voltage battery 34, and temperature adjustment of the motor 35 and the power inverter 36. Accordingly, the refrigeration cycle system 37, the electric compressor 38, the water circuit system 39, and the electric heater 40 constitute a temperature control apparatus 46 that performs various temperature adjustments in the vehicle 30.

The retrofit load inverter 42 is an inverter for supplying power to one or more electrical loads retrofittable to the vehicle 30, that is, retrofit electrical loads.

The retrofit load inverter 42 is configured to convert a voltage, i.e., a high voltage, across the high-voltage battery 34 into a voltage suitable for the one or more retrofit electrical loads, and supply power based on the converted voltage to the one or more retrofit electrical loads. For example, the one or more retrofit electrical loads may include household appliances, such as a portable refrigerator-freezer connected to an AC 100 V outlet provided in the vehicle 30.

The auxiliary DC-DC converter 43 is configured to convert high-voltage power, which is the voltage, i.e., the high voltage across the high-voltage battery 34, into low-voltage power with a predetermined low voltage, such as DC 12 V or DC 48 V. The auxiliary DC-DC converter 43 is configured to supply the converted low-voltage power to each of auxiliaries, which are a plurality of general electric loads of the vehicle 30.

The charger 44 includes a charging socket into which a charging plug for supplying power from outside the vehicle 30 to the vehicle 30 is insertable, and an electric circuit for controlling the supply of the electric power. The charger 44 is configured to adjust the voltage of the power supplied from outside the vehicle 30 and thereafter supply the adjusted power to the high-voltage battery 34. This enables the high-voltage battery 34 to be charged.

The high-voltage battery 34, the motor 35, the drive inverter 36, the refrigeration cycle system 37, the electric compressor 38, the water circuit system 39, the electric heater 40, the retrofit load inverter 42, the auxiliary DC-DC converter 43, and the charger 44 described above are each electrically connected to the in-vehicle computer 32 as control targets.

The in-vehicle computer 32 is configured to determine command values CD for the respective control targets, and output control signals indicating the command values CD to the respective control targets, thus controlling the control targets.

The vehicle 30 further includes an information acquisition unit 90. The information acquisition unit 90 is connected to the in-vehicle computer 32 and the communication device 33, and is configured to acquire information from plural sensors VS, a navigation device ND, GPS (Global Positioning System), and the cloud 50. A measurement signal output from each of the sensors VS, the navigation device ND, the GPS, and the cloud 50, which includes a physical quantity measured thereby, is input to the in-vehicle computer 32. The sensors VS include a vehicle speed sensor for measuring a speed of the vehicle 30, a cabin temperature sensor for measuring the temperature in the cabin of the vehicle 30, and a battery temperature sensor for measuring the temperature of the high-voltage battery 34.

The HMI unit 45 is comprised of an interface unit 45a and a controller 45b having an input function of inputting, through the interface unit 45a, various data items from an occupant 80 as a user, and an output function of providing, through the interface unit 45a, various information the occupant 80. Examples of the HMI unit 45 include, as the interface unit 45a, a touch-panel display having a display function as the output function and the input function, and is provided on an instrument panel in the cabin 30a.

Examples of the input information, which is input from the occupant 80 through the interface unit 45a of the HMI unit 45, include a destination to be used for travel planning by the cloud computer 52, which will be described later, and requests of the occupant 80 related to the travel planning. Examples of the requests of the occupant 80 include a desired value for the remaining energy of the high-voltage battery 34 when the vehicle 30 arrives at the destination, or a desired level of the remaining energy of the high-voltage battery 34, such as low, medium, or high.

Examples of the output information, which is output through the interface unit 45a of the HMI unit 45 to the occupant 80, include information indicating a recommended travel route in the travel planning. Additionally, examples of the output information, which is output through the interface unit 45a of the HMI unit 45 to the occupant 80, include respective positions of charging facilities available in the travel planning and a sequence of a target speed Vct of the vehicle 30 to be used in the travel planning.

A travel plan to be prepared and determined by the cloud computer 52 will be referred to as a travel plan PN.

Information that is to be provided to the in-vehicle computer 32 without being provided to the occupant 80 is transmitted from the cloud 50 to the vehicle 30, so that the information is received by the in-vehicle computer 32. Examples of the information to be provided to the in-vehicle computer 32 include a target temperature for controlling the temperature of the high-voltage battery 34 in preparation for charging the high-voltage battery 34. The remaining energy of the high-voltage battery 34 will also be referred to simply as a charging level or a charging remaining level of the high-voltage battery 34. The charging facilities CG will also be referred to as charging stations. The high-voltage battery 34 can be charged from the charger 44 illustrated in FIG. 2 at each of the charging facilities.

The manager 51 of the cloud 50 functions to aggregate information transmitted and received among (i) the communication device 33 of the vehicle 30, (ii) an API service 54 provided in the cloud 50, and (iii) the cloud computer 52.

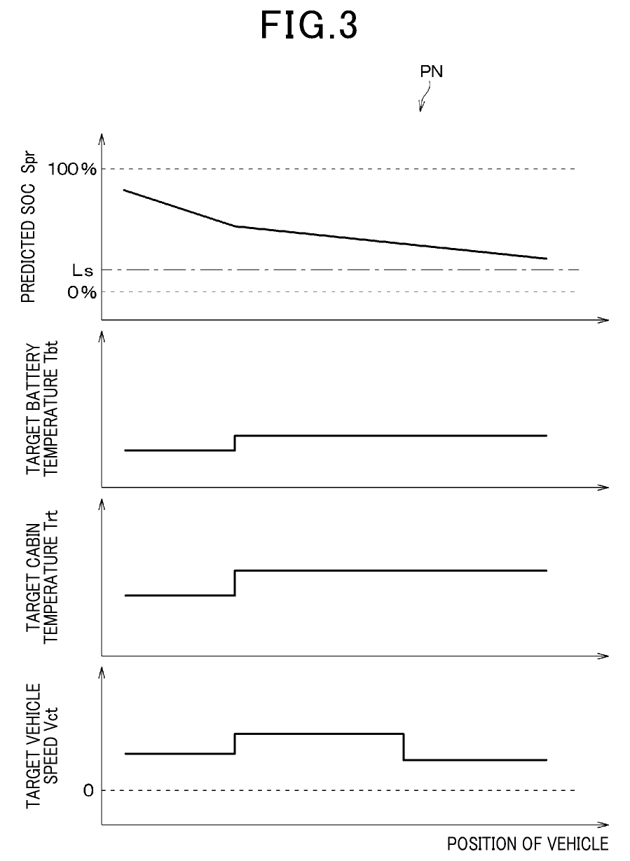

The cloud computer 52 is configured to receive various information, which include the information input from the HMI unit 45 via the manager 51, and, for example, calculate a travel plan PN related to energy of the vehicle 30 traveling to the occupant’s requested destination in accordance with an occupant’s purpose (see FIG. 3). That is, the cloud computer 52 is configured to prepare and determine the travel plan PN. If information regarding the vehicle 30 is required for the calculation of the travel plan, the information is transmitted as appropriate from the vehicle 30 to the cloud 50. For example, the information can be inputted from the HMI unit 45 to the could 52 set forth above.

Examples of the information regarding the vehicle 30 include various information items respectively indicating (i) a present level of the remaining energy of the high-voltage battery 34, (ii) a value of the temperature of the high-voltage battery 34, and (iii) a current position of the vehicle 30.

The API service 54 is, for example, implemented on a server in the cloud 50. When defining the API service 30 in the cloud 50, one of its functions is to act as a mechanism that allows hardware/software components within the cloud 50 to communicate with (i) other internal cloud components and (ii) external hardware/software components, through a predefined set of definitions and protocols.

For example, the current position of the vehicle 30 may be obtained from the information acquisition unit 90, such as, at least one of the GPS, the navigation device ND of the vehicle 30, and the various sensors VS of the vehicle 30. The travel plan PN is a vehicle travel plan determined prior to actual traveling of the vehicle 30, which will be described in detail later. The current position of the vehicle 30 is also referred to as a vehicle current position.

The travel plan PN calculated and completed by the cloud computer 52 is transmitted to the in-vehicle computer 32 via the manager 51, the wireless network NW, and the communication device 33. When functions related to calculation of the travel plan PN are distributed among a plurality of computers, the manager 51 also has a function of integrally controlling the plurality of computers.

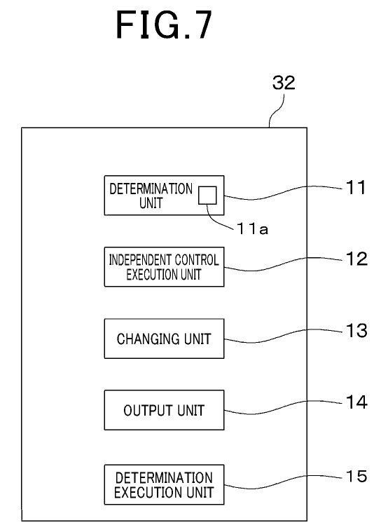

The in-vehicle computer 32, which serves as, for example, control circuitry, of the first embodiment functionally includes, for example, a determination unit 11, an independent control execution unit 12, a changing unit 13, an output unit 14, and a determination execution unit 15 (see FIG. 7).

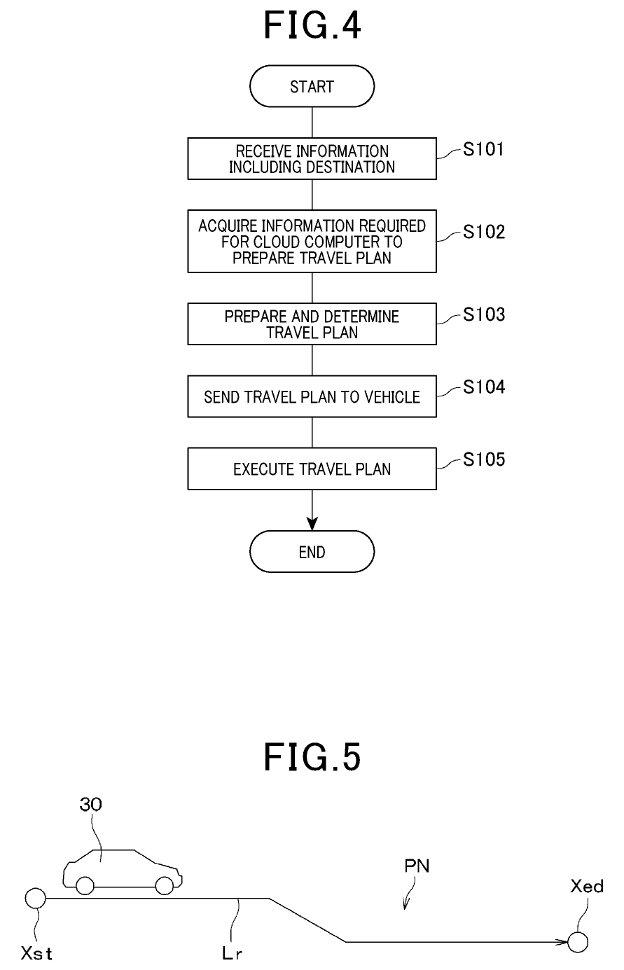

Specifically, the cloud computer 52 of the cloud 52 is configured to prepare a travel plan PN for the vehicle 30 in accordance with the flowchart illustrated in FIG. 4, and the in-vehicle computer 32 is configured to execute the travel plan PN. The cloud computer 52 is programmed to start a control routine illustrated in the flowchart of FIG. 4 in response to occupant’s manual operations through the HMI unit 45.

As illustrated in FIGS. 3 and 5, the travel plan PN includes a scheduled travel route Lr. The scheduled travel route Lr is a travel route of the vehicle 30 recommended in the travel plan PN, in other words, a travel plan scheduled for the vehicle 30 to travel and presented to the occupant 80. The travel plan PN includes, for example, at least one charging facility selected to be stopped during the scheduled travel route Lr and a transition of a target temperature of at least one in-vehicle device.

Specifically, the travel plan PN according to the first embodiment includes, in addition to the scheduled travel route Lr and the information on the at least one charging facility, (i) a transition of the target speed Vct of the vehicle 30 (i.e., the target vehicle speed Vct) from a start point Xst to an end point Xed of the scheduled travel route Lr, (ii) a transition of a target temperature Trt in the cabin 30a (i.e., the target cabin temperature Trt), (iii) a transition of a target temperature Tbt of the high-voltage battery 34 (i.e., the target battery temperature Tbt, and (iv) a transition of a predicted charge rate, i.e., a state of charge (SOC), Spr (i.e., the predicted SOC Spr).

The target vehicle speed Vct denotes a target value of the speed of the vehicle 30, the target cabin temperature Trt denotes a target value of the temperature in the cabin 30a of the vehicle 30, which is to be adjusted by air-conditioning in the cabin 30a. The target battery temperature Tbt denotes a target value of the temperature of the high-voltage battery 34. The predicted SOC of the high-voltage battery 34 denotes a predicted value of the SOC of the high-voltage battery 34, which is predicted by the cloud computer 52.

FIG. 3 illustrates a combination of graphs having a common horizontal axis that represents the position of the vehicle 30 on the scheduled travel route Lr, and vertical axes of the respective graphs indicate the target vehicle speed Vct, the target battery temperature Tbt, the target cabin temperature Trt, and the predicted SOC Spr of the high-voltage battery 34, respectively.

The travel plan PN is, as illustrated in FIGS. 3 and 5, a travel plan that includes the scheduled travel route Lr and causes the vehicle speed and one or more other physical quantities related to energy consumption of the vehicle 30 to transition in accordance with the traveling of the vehicle 30. For example, as seen by the illustration that the vertical axis of FIG. 3 includes the target cabin temperature Trt and the target batter temperature Tbt, the one or more other physical quantities include the temperature in the cabin 30a and the temperature of the high-voltage battery 34.

When starting the control routine, the cloud computer 52 receives information, which is input thereto by occupant’s information input operations through the HMI unit 45 in step S101. The information input operations by the occupant 80 herein means that the occupant 80 inputs, through the interface unit 45a of the HMI unit 45, information to the controller 45b of the HMI unit 45; the cloud computer 52 is configured to refer to the input information for performing a travel-plan preparation. For example, as the information input operations, the occupant 80 inputs, through the interface unit 45a of the HMI unit 45, a destination of a travel plan.

In addition, the occupant 80 may also input, through the interface unit 45a of the HMI unit 45, (i) a desired value of the remaining energy of the high-voltage battery 34 or a desired level of the remaining energy when the vehicle 30 arrives at the destination, (ii) permission or prohibition of use of toll roads in the travel plan, and (iii) preference information indicating preferences of the occupant 80.

Examples of the preference information include information on the adjustment of the strength of air conditioning in the cabin 30a and/or information indicative of whether priority is given to travel time or to energy efficiency in the travel planning.

Various methods of occupant’s input operations through the interface unit 45a of the HMI unit 45 for example include, when a touch panel display is provided as the interface unit 45a, occupant’s operation of one or more visual switches and/or one or more extendable visual bars displayed on the touchscreen of the touch panel display. The input information entered into the controller 45b of the HMI unit 45 is transmitted from the controller 45b to the cloud computer 52 via the communication device 33 and the wireless network NW.

After the operation in step S101 of FIG. 4, the control routine proceeds to step S102.

In step S102, the cloud computer 52 acquires travel-plan basic information, which is information required to determine (i) a scheduled travel route Lr in a travel plan PN of the vehicle 30, (ii) a sequence of the target vehicle speed Vct during travel of the vehicle 30, (iii) a sequence of the target cabin temperature Trt, and (iii) a sequence of the target battery temperature Tbt. Examples of the travel plan basic information include the information including the current position of the vehicle 30 and the destination entered in step S101 and the external information; the external information includes (i) information indicative of the ambient temperature around the vehicle 10 and (ii) information indicative of traffic congestion around the vehicle 30.

Examples of the travel plan basic information further include vehicle information indicating a condition of the vehicle 30, such as at least one of vehicle-speed information indicating the speed of the vehicle 30 and battery information indicating the present state (for example, the SOC and temperature) of the high-voltage battery 34.

The external information may be obtained from the API service 54 in step S102. After the operation in step S102 of FIG. 4, the control routine proceeds to step S103.

In step S103, the cloud computer 52 prepares and determines the travel plan PN, which includes the scheduled travel route Lr, of the vehicle 30 based on the travel plan basic information acquired in step S102. For example, the cloud computer 52 determines the travel plan PN using, for example, a known optimization algorithm. For example, when a plurality of travel-route candidates are provided by the existing API service 54, the cloud computer 52 selects one travel-route candidate from the plurality of travel-plan candidates, and determines the selected travel-route candidate as the scheduled travel route Lr of the travel plan.

The scheduled travel route Lr along which the vehicle 30 is going to travel from the current position to the destination is comprised of a plurality of predetermined sections.

The start point Xst of the scheduled travel route Lr is set to the current position of the vehicle 30, and the end point Xed of the scheduled travel route Lr is set to the destination that is input by the occupant 80.

In step S103, the cloud computer 52 determines, as components of the travel plan PN, various parameters, which include, for example, (i) the sequence of values of the target vehicle speed Vct at the respective sections of the scheduled travel route Lr, (ii) the sequence of values of the target battery temperature Trt at the respective sections of the scheduled travel route Lr, and (iii) the sequence of values of the target cabin temperature Tbt at the respective sections of the scheduled travel route Lr.

If there is a need of charging the vehicle 30 during the vehicle’s traveling along the scheduled travel route Lr, the cloud computer 52 determines, as the components of the travel plan PN, the various parameters including (i) at least one charging facility at which the vehicle 30 can stop along the scheduled travel route Lr for battery charging and (ii) the amount of charging energy at the at least one charging facility.

An evaluation function is defined for the various parameters such that a higher evaluation corresponds to a larger value, and the various parameters are determined so that the evaluation function value is maximized. Examples of the evaluation function include a function defined to increase with improvement of travel time, energy efficiency, remaining energy of the high-voltage battery 34, and/or risk of insufficient battery charge.

In particular, the cloud computer 52 determines the travel plan PN that enables the vehicle 30 to travel based on the travel plan PN while ensuring that the SOC of the high-voltage battery 34 remains not less than a predetermined allowable lower limit Ls (see FIG. 3) in step S103. More specifically, the cloud computer 52 calculates a sequence of values of the predicted SOC Spr of the high-voltage battery 34 at the respective sections of the scheduled travel route Lr from the start point Xst to the end point Xed (see FIG. 3) in step S103. Then, the cloud computer 52 determines the travel plan PN such that all the values of the predicted SOC Spr of the high-voltage battery 34 remain not less than the predetermined allowable lower limit Ls.

For example, the cloud computer 52 calculates, for each section of the scheduled travel route Lr, the predicted SOC based on (i) a travel energy efficiency, i.e., energy consumption rate, of the vehicle 30, (ii) the scheduled travel route Lr, and (iii) the corresponding value of the target cabin temperature Trt. The travel energy efficiency of the vehicle 3, expressed in, for example, kilometers per kilowatt-hour (km/kWh), denotes the distance the vehicle 30 can travel for each unit of electrical energy consumed. The allowable lower limit Ls may be experimentally set in advance to a fixed value that prevents insufficient battery charge of the vehicle 30 or a value variable depending on the preference information on the occupant 80 acquired in step S102.

After the operation in step S103 of FIG. 4, the control routine proceeds to step S104.

In step S104, the cloud computer 52 sends the travel plan PN determined in step S103 as illustrated in FIGS. 3 and 5 to the manager 51, and the manager 51 transmits the travel plan PN to the vehicle 30 via the wireless network NW and the in-vehicle communication device 33. That is, the travel plan PN determined in advance by the cloud computer 52 serving as an external computer is input to the in-vehicle computer 32.

The travel plan PN includes, for example, (i) the scheduled travel route Lr, (ii) the sequence of values of the target vehicle speed Vct at the respective sections of the scheduled travel route Lr, (iii) the sequence of values of the target cabin temperature Trt at the respective sections of the scheduled travel route Lr, (iv) the sequence of values of the target battery temperature Tbt at the respective sections of the scheduled travel route Lr, and (v) the sequence of values of the predicted SOC Spr of the high-voltage battery 34 at the respective sections of the scheduled travel route Lr. If necessity arises, the travel plan PN includes a position of at least one charging facility at which the vehicle 30 can stop along the scheduled travel route Lr for battery charging and the amount of charging energy at the at least one charging facility.

After the operation in step S104 of FIG. 4, the control routine proceeds to step S105.

In step S105, the in-vehicle computer 32 receives the travel plan PN input thereto, and executes the travel plan PN. Specifically, the determination execution unit 15 of the in-vehicle computer 32 executes control in accordance with the travel plan PN. For example, the determination execution unit 15 starts the control in accordance with the travel plan PN simultaneously with occupant’s, i.e., driver’s, operation of starting the vehicle 30, and presents various information related to the travel plan PN, including, for example, the scheduled travel toute Lr, the target vehicle speed Vct, and the target cabin temperature Trt to the occupant 80 through the interface unit 45a of the HMI unit 45.

The vehicle 30 of the first embodiment is a vehicle capable of automatically controlling the speed thereof. During execution of the travel plan PN, because the speed of the vehicle 30 is automatically controlled but the vehicle’s path is not automatically controlled, a guidance in accordance with the scheduled travel route Lr is visually and/or audibly provided to the occupant, i.e., driver, 80 through the interface 45a of the HMI unit 45, so that the occupant (driver) 80 operates the steering wheel of the vehicle 30 in accordance with the guidance. This enables the vehicle 30 to travel along the scheduled travel route Lr.

Specifically, when starting execution of the travel plan PN, the in-vehicle computer 32 controls both the motor 35 and the drive inverter 36 to cause the vehicle 30 to travel such that the speed of the vehicle 30 approaches the sequence of the values of the target vehicle speed Vct of the travel plan PN. In other words, the in-vehicle computer 32 controls both the motor 35 and the drive inverter 36 to cause the vehicle 30 to travel such that the speed of the vehicle 30 at each section of the scheduled travel route Lr becomes the corresponding value of the target vehicle speed Vct of the travel plan PN at the corresponding section.

Additionally, when starting execution of the travel plan PN, the in-vehicle computer 32 controls the temperature control apparatus 46 such that the temperature in the cabin 30a approaches the sequence of the values of the target cabin temperature Trt of the travel plan PN. In other words, the in-vehicle computer 32 controls the temperature control apparatus 46 such that the temperature in the cabin 30a at each section of the scheduled travel route Lr becomes the corresponding value of the target cabin temperature Trt of the travel plan PN at the corresponding section. Similarly, when starting execution of the travel plan PN, the in-vehicle computer 32 controls the temperature control apparatus 46 such that the temperature of the high-voltage battery 34 approaches the sequence of the values of the target battery temperature Tbt of the travel plan PN. In other words, the in-vehicle computer 32 controls the temperature control apparatus 46 such that the temperature of the high-voltage battery 34 at each section of the scheduled travel route Lr becomes the corresponding value of the target battery temperature Tbt of the travel plan PN at the corresponding section.

As described above, the speed of the vehicle 30, the temperature in the cabin 30a, and the temperature of the high-voltage battery 34 are automatically controlled during execution of the travel plan PN. Additionally, each of the target vehicle speed Vct, the target cabin temperature Trt, and the target battery temperature Tbt is automatically controlled according to the travel plan PN and the vehicle’s progress.

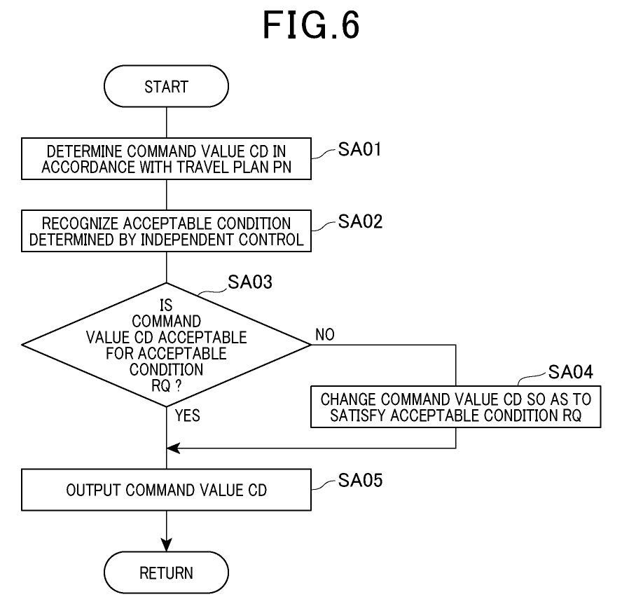

When execution of the travel plan PN is started, the vehicle speed control, which controls both the motor 35 and the drive inverter 36 to bring the vehicle speed closer to the target vehicle speed Vct is started. In detail, as the vehicle speed control during execution of the travel plan PN, the in-vehicle computer 32 is configured to execute a control routine illustrated in FIG. 6. That is, the in-vehicle computer 32 is configured to start the control routine illustrated in FIG. 6 in response to starting execution of the travel plan PN in step S105 of FIG. 4. The in-vehicle computer 32 is configured to cyclically execute the control routine illustrated in FIG. 6.

When starting the control routine illustrated in FIG. 6, the determination unit 11 determines the command value CD for controlling the motor 35 so that the motor 35 operates in accordance with the travel plan PN in step SA01. The command value CD corresponds to, for example, a command parameter according to the first embodiment. The in-vehicle computer 32 outputs, to the drive inverter 36, a control signal indicative of the command value CD in step SA05 described later, thus controlling the motor 35 through the drive inverter 36.

Specifically, to determine the command value CD, the determination unit 11 recognizes the value of the target vehicle speed Vct corresponding to the section of the scheduled travel route Dr in which the vehicle current position is located, and recognizes the speed of the vehicle 30 based on the measurement signal of the vehicle speed sensor included in the sensors VS in step SA01.

Then, the determination unit 11 calculates an absolute difference between the value of the target vehicle speed Vct and the speed of the vehicle 30, and calculates, as the command value CD, output torque of the motor 35 required to bring the speed of the vehicle 30 to the value of the target vehicle speed Vct in step SA01. The output torque of the motor 35 is also referred to as motor torque. For example, when the speed of the vehicle 30 is lower than the value of the target vehicle speed Vct, the motor torque becomes greater as the absolute difference between the value of the target vehicle speed Vct and the speed of the vehicle 30 becomes greater. After the operation in step SA01, the control routine illustrated in FIG. 6 proceeds to step SA02.

The independent control execution unit 12 included in the in-vehicle computer 32 executes independent control, including safety-related control for safety traveling of the vehicle 30, in parallel with the execution of the travel plan PN.

That is, the independent control execution unit 12 performs the independent control separately from the travel plan PN. For example, the safety-related control may include at least one of collision avoidance control, inter-vehicle distance control, slip traction control, and pre-curve deceleration control.

The collision avoidance control denotes vehicle control that prevents a collision of the vehicle 30. The inter-vehicle distance control denotes vehicle control that maintains a predetermined distance between the vehicle 30 and a preceding vehicle. The slip traction control denotes vehicle control that suppresses slipping of the driving wheels 301 of the vehicle 30. The pre-curve deceleration control denotes vehicle control that decelerates the vehicle 30 before entering a curve based on map information or the like obtained from the navigation device ND.

In order to achieve the object of the independent control, the independent control execution unit 12 determines an acceptable condition RQ that defines an acceptable range of the motor torque as the command value CD, and sequentially updates the acceptable condition RQ in accordance with changes in the vehicle state.

For example, when the independent control is the safety-related control, the object of the safety-related control is to ensure safe travel of the vehicle 30 When it is determined that the command value CD satisfies the acceptable condition RQ, this determination means that the control of the motor torque in the independent control is being executed normally. The acceptable condition RQ may be defined as an upper-lower limit range that includes an upper limit and a lower limit of the command value CD, or as a single torque value without a range.

Following the operation in step SA01, the independent control execution unit 12 recognizes the acceptable condition RQ determined by the independent control in step SA02. After the operation in step SA02, the control routine proceeds to step SA03.

In step SA03, the changing unit 13 determines whether the command value CD determined in step SA01 is acceptable for the acceptable condition RQ, i.e., whether the command value CD is consistent with the acceptance condition RQ. For example, let us assume that the acceptable condition RQ is defined as the upper-lower limit range of the command value CD. In this assumption, when the command value CD lies within the acceptable range RQ, it is determined that the command value CD is acceptable for the acceptable condition RQ. Alternatively, let us assume that the acceptable condition RQ is defined as a specific torque value. In this assumption, when the command value CD matches the specific torque value, it is determined that the command value CD is acceptable for the acceptable condition RQ.

In response to determination that the command value CD satisfies the acceptable condition RQ (YES in step SA03), the control routine proceeds to step SA05. Otherwise, in response to determination that the command value CD does not satisfy the acceptable condition RQ (NO in step SA03), that is, when the command value CD deviates from the acceptable condition RQ, the control routine proceeds to step SA04.

In step SA04, the changing unit 13 changes the command value CD so as to satisfy the acceptable condition RQ. For example, when the acceptable condition RQ is defined as the specific torque value, the modification unit 13 changes the command value CD to the specific torque value.

Alternatively, when the acceptable condition RQ is defined as the upper-lower limit range, the changing unit 13 changes the command value CD to a value within the upper-lower limit range.

Specifically, when the command value CD exceeds the upper limit of the upper-lower limit range, the changing unit 13 changes the command value CD to the upper limit, and when the command value CD is below the lower limit of the upper-lower limit range, the changing unit 13 changes the command value CD to the lower limit of the upper-lower limit range.

For example, let us assume that the command value CD determined in step SA01 is the motor torque of 20 Nm, and the upper-lower limit range as the acceptable condition RQ is defined as 0-15 Nm. In this assumption, the changing unit 13 changes the command value CD from 20 Nm to the upper limit of 15 Nm in step SA04. After the operation in step SA04, the control routine proceeds to step SA05.

In step SA05, the output unit 14 outputs the control signal indicating the command value CD to the drive inverter 36. This causes the drive inverter 36 to operate the motor 35 as the control object according to the command value CD. That is, the motor 35 is rotatably driven by the drive inverter 36 to generate motor torque corresponding to the command value CD. Because the motor 35 is coupled to the driving wheels 301, the driving wheels 301 are rotationally driven, so that the speed of the vehicle 30 d is thereby adjusted. After the operation in step SA05, the control routine returns to step SA01.

As described above, the in-vehicle computer 32 of the first embodiment determines, in step SA01, the command value CD for controlling the motor 35 as the control object such that the motor 35 operates in accordance with the travel plan PN.

In response to determination that the command value CD determined in step SA01 deviates from the acceptable condition RQ determined by the independent control, the in-vehicle computer 32 changes the command value CD so as to satisfy the acceptable condition RQ.

This makes it possible to, when the command value CD determined for the travel plan PN conflicts with the acceptable condition RQ determined by the independent control, give higher priority to the independent control than the travel plan PN. Accordingly, the in-vehicle computer 32 properly coordinates the independent control, which has higher priority, and the travel plan PN while executing the travel plan PN. This therefore results in the vehicle 30 continuously traveling based on the travel plan PN without hindering the execution of the higher-priority independent control.

Additionally, the independent control includes safety-related control, and the control target operated based on the command value CD is the motor 35 serving as a power source for vehicle propulsion. The motor 35 is controlled to operate based on the command value CD, thus adjusting the speed of the vehicle 30. This configuration therefore makes it possible to cause the vehicle 30 to continuously travel based on the travel plan PN without compromising the safety of vehicle’s travel.

### SECOND EMBODIMENT

Next, the following describes the second embodiment of the present disclosure. In particular, the following mainly describes different points of the second embodiment, which are different from the first embodiment.

The description of the same or equivalent components as those in the aforementioned first embodiment will be omitted or simplified. This also applies to the description of the later-described embodiments and modifications.

In the vehicle 30 of the second embodiment, cruise control function is installed, which enables the vehicle 30 to autonomously control the speed of the vehicle 30. The cruise control of the second embodiment is one type of the vehicle speed control executed by the in-vehicle computer 32, and specifically corresponds to either constant-speed cruise control or adaptive cruise control.

The constant-speed cruise control denotes vehicle speed control that causes the vehicle speed to converge to a constant value of the target vehicle speed Vct specified by the occupant 80.

The adaptive cruise control denotes vehicle speed control that causes the vehicle 30 to follow a preceding vehicle and converge the vehicle speed to a constant value of the target vehicle speed Vct specified by the occupant 80 within a range in which the vehicle 30 is able to follow the preceding vehicle.

For example, the controller 45b of the HMI unit 45 according to the second embodiment is configured to receive a turn-on instruction or a turn-off instruction of the cruise control in response to manual operations by the occupant 80 via the interface unit 45a. When the turn-on instruction of the cruise control is inputted by the occupant 80, the in-vehicle computer 32 executes the cruise control. Otherwise, when the turn-off instruction of the cruise control is inputted by the occupant 80, the in-vehicle computer 32 does not execute the cruise control or stop the cruise control. In other words, the turn-on instruction of the cruise control instructs the in-vehicle computer 32 to execute the cruise control, and the turn-off instruction of the cruise control instructs the in-vehicle computer 32 not to execute the cruise control.

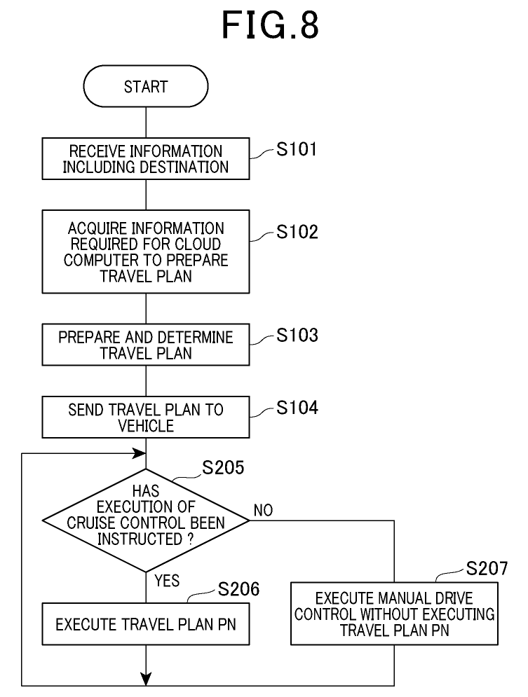

As will be described later, the in-vehicle computer 32 of the second embodiment may execute the travel plan PN in a control routine illustrated in FIG. 8. In such a case, the in-vehicle computer 32 is configured to execute the vehicle speed control based on the travel plan PN instead of the normal cruise control (i.e., the constant-speed or adaptive cruise control). That is, when executing the travel plan PN, the in-vehicle computer 32 does not execute the normal cruise control.

The travel plan PN according to the second embodiment is formulated in the same manner as in the first embodiment. In particular, the in-vehicle computer 32 is configured to execute the control routine illustrated in FIG. 8 instead of the control routine illustrated in FIG. 4, thus creating the travel plan PN.

The operations in steps S101 to S104 in the flowchart of FIG. 8 respectively correspond to operations in steps S101 to S104 in the flowchart of FIG. 4. In FIG. 8, operations in steps S205 to S207 are added to the flowchart of FIG. 4, and an operation in step S206, which corresponds to the operation in step S105 of FIG. 4, is provided in place of the operation in step S105.

As illustrated in FIG. 8, following the operation in step S104, the determination execution unit 15 of the in-vehicle computer 32 determines, in step S205, whether the turn-on instruction of the cruise control has been indicted by the occupant 80, in other words, whether execution of the cruise control has been instructed by the occupant 80. For example, the in-vehicle computer 32 may be configured to make this determination based on a signal indicating the occupant’s operation received from the controller 45b of the HMI unit 45 via the interface unit 45a.

In response to determination that the turn-on instruction of the cruise control has been indicated by the occupant 80, that is, execution of the cruise control has been instructed by the occupant 80 (YES in step S205), the control routine proceeds to step S206. Otherwise, in response to determination that the turn-off instruction of the cruise control has been indicated by the occupant 80, that is, stop of execution of the cruise control has been instructed by the occupant 80 (NO in step S205), the control routine proceeds to step S207.

In step S206, the determination execution unit 15 of the in-vehicle computer 32 executes the travel plan PN received in step S104, in the same manner as the operation in step S105 of FIG. 4. As illustrated in FIG. 3, the travel plan PN includes the transition of each of the target vehicle speed Vct, the target cabin temperature Trt, the target battery temperature Tbt, and the predicted SOC Spr with the traveling of the vehicle 30. For this reason, the vehicle speed control is, for example, executed in accordance with the travel plan PN.

Additionally, when the in-vehicle computer 32 is already executing the travel plan PN, the in-vehicle computer 32 continues the execution of the travel plan PN. After the operation in step S206, the control routine returns to step S205.

Note that the in-vehicle computer 32 executes the control routine illustrated in FIG. 6 in the same manner as in the first embodiment. That is, when starting execution of the travel plan PN in step S206 of FIG. 8, the in-vehicle computer 32 simultaneously starts the control routine illustrated in FIG. 6, and cyclically executes the control routine illustrated in FIG. 6 until the travel plan PN is terminated.

In step S207 illustrated in FIG. 8, the determination execution unit 15 of the in-vehicle computer 32 does not execute the travel plan PN. That is, the in-vehicle computer 32 does not execute the normal cruise control (the constant-speed or adaptive cruise control). In other words, the in-vehicle computer 32 executes manual driving-power control that increases or decreases the output of the motor 35 serving as the power source in accordance with the accelerator pedal operations of the driver (occupant) 80. In step S207, when the in-vehicle computer 32 is already executing the manual driving-power control, the in-vehicle computer 32 continues the manual driving-power control while remaining the travel plan PN stopped. After the operation in step S207, the control routine returns to step S205.

As described above, the in-vehicle computer 32 of the second embodiment is configured to execute the travel plan PN in step S206 of FIG. 8 and simultaneously execute the control routine of FIG. 6 in response to determination that execution of the cruise control is instructed by the occupant 80.

That is, when execution of the cruise control is instructed by the occupant 80, the determination unit 11 determines, in step SA01 of FIG. 6, the command value CD for controlling the motor 35, thus instructing the motor 35 to operate in accordance with the travel plan PN. Otherwise, when stop of execution of the cruise control is instructed by the occupant 80, the determination unit 11 determines not to execute the control routine of FIG. 6.

That is, the in-vehicle computer 32 of the second embodiment is configured such that the determination unit 11 is capable of selecting (i) determining the command value CD that instructs the motor 35 to operate in accordance with the travel plan PN or (ii) not determining the command value CD.

Accordingly, the in-vehicle computer 32 of the second embodiment executes automatic control of the speed of the vehicle 30 in accordance with the travel plan PN while adjustment of the speed of the vehicle 30 is entrusted with the in-vehicle computer 32 of the vehicle 30, making it possible to reduce any sense of discomfort felt by the occupant 80 due to the automatic control of the vehicle speed in accordance with the travel plan PN.

Except for the above descriptions, the second embodiment is substantially identical to the first embodiment, and therefore achieves the same advantageous benefits as those achieved from the common configuration shared with the first embodiment.

### THIRD EMBODIMENT

Next, the following describes the third embodiment of the present disclosure. In particular, the following mainly describes different points of the third embodiment, which are different from the second embodiment.

The controller 45b of the HMI unit 45 according to the third embodiment is configured to receive the turn-on instruction or the turn-off instruction of the cruise control in response to manual operations by the occupant 80 via the interface unit 45a. This is the same as the first embodiment.

In particular, the controller 45b of the HMI unit 45 according to the third embodiment is configured to receive an instruction indicative of execution permission of the travel plan PN based on predetermined manual operations by the occupant 80 via the interface unit 45a. For example, the interface unit 45a of the HMI unit 45 includes one or more switches manually operable by the occupant 80 for inputting the instruction indicative of the execution permission of the travel plan PN. The controller 45b is configured to receive the instruction indicative of the execution permission of the travel plan PN inputted by occupant’s switching operations of the switches of the interface unit 45a.

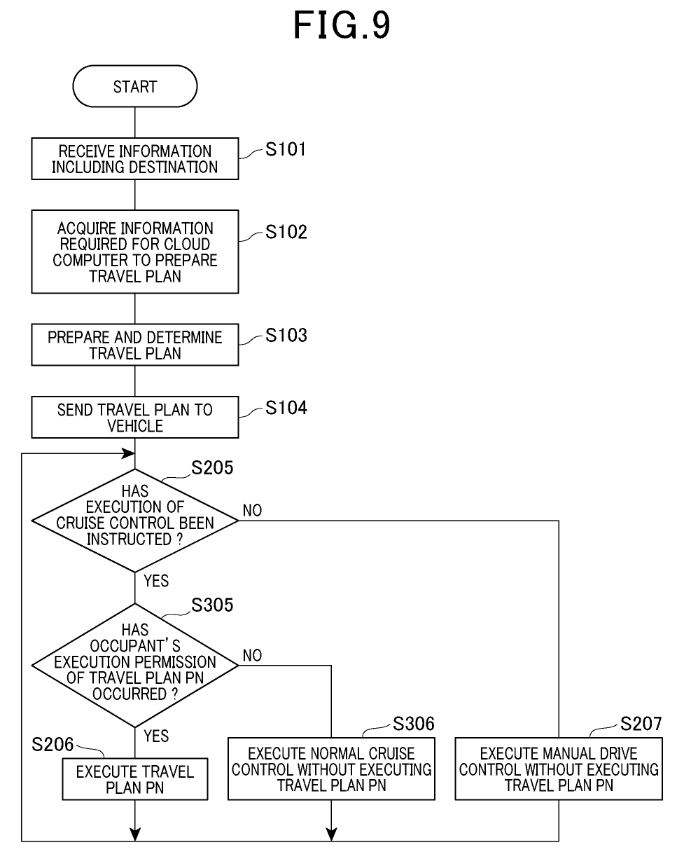

The in-vehicle computer 32 of the third embodiment is configured to execute a control routine illustrated in FIG. 9 in place of the control routine illustrated in FIG. 8. In FIG. 9, operations in steps S305 and S306 are added to the flowchart of FIG. 8.

As illustrated in FIG. 9, following the operation in step S104, the determination execution unit 15 of the in-vehicle computer 32 determines, in step S205, whether execution of the cruise control has been instructed by the occupant 80.

In response to determination that the turn-on instruction of the cruise control has been indicated by the occupant 80 (YES in step S205), the control routine proceeds to step S305. Otherwise, in response to determination that the turn-off instruction of the cruise control is indicated by the occupant 80 (NO in step S205), the control routine proceeds to step S207.

In step S305, the determination execution unit 15 of the in-vehicle computer 32 determines whether the execution permission of the travel plan PN has occurred based on the predetermined manual operations by the occupant 80 through the interface unit 45a. The predetermined manual operations by the occupant 80 mean occupant’s input operations, i.e., occupant’s plan permission operations, through the interface unit 45a, which instructs the execution permission of the travel plan PN. For example, the in-vehicle computer 32 may be configured to make this determination based on a signal indicating the execution permission of the travel plan PN, which has been indicated by the occupant 80 through the interface unit 45a, received from the controller 45b of the HMI unit 45 via the interface unit 45a.

In response to determination that the execution permission of the travel plan PN has occurred based on the predetermined manual operations by the occupant 80 through the interface unit 45a (YES in step S305), the control routine proceeds to step S206. Otherwise, in response to determination that no execution permission of the travel plan PN has occurred based on the predetermined manual operations by the occupant 80 through the interface unit 45a (NO in step S305), the control routine proceeds to step S306

In step S306, the determination execution unit 15 of the in-vehicle computer 32 does not execute the travel plan PN, and executes the normal cruise control (the constant-speed or adaptive cruise control). In step S306, when the in-vehicle computer 32 is already executing the normal cruise control, the in-vehicle computer 32 continues the normal cruise control while remaining the travel plan PN stopped. After the operation in step S306, the control routine returns to step S205.

As described above, the in-vehicle computer 32 of the third embodiment is configured to execute the travel plan PN in step S206 of FIG. 9 and simultaneously execute the control routine of FIG. 6 in response to determination that the execution permission of the travel plan PN has occurred based on the predetermined manual operations (i.e., plan permission operations) by the occupant 80 through the interface unit 45a.

That is, when the execution permission of the travel plan PN has occurred based on the predetermined manual operations, the determination unit 11 determines, in step SA01 of FIG. 6, the command value CD for controlling the motor 35, thus instructing the motor 35 to operate in accordance with the travel plan PN.

Accordingly, the occupant 80 permits the execution permission of the travel plan PN through his/her predetermined manual operations, and the in-vehicle computer 32 executes the travel plan PN in response to the occurrence of the execution permission of the travel plan PN based on the occupant’s predetermined manual operations. This therefore makes it possible to reduce any sense of discomfort felt by the occupant 80 due to the automatic control of the vehicle speed in accordance with the travel plan PN.

Except for the above descriptions, the third embodiment is substantially identical to the second embodiment, and therefore achieves the same advantageous benefits as those achieved from the common configuration shared with the second embodiment.

### FOURT EMBODIMENT

Next, the following describes the fourth embodiment of the present disclosure. In particular, the following mainly describes different points of the fourth embodiment, which are different from the second embodiment.

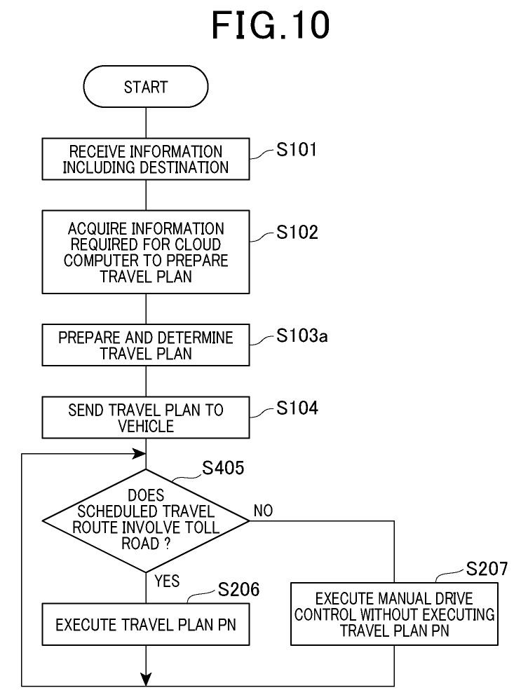

The in-vehicle computer 32 of the fourth embodiment is configured to execute a control routine illustrated in FIG. 10 in place of the control routine illustrated in FIG. 8. In FIG. 10, an operation in step S103a, which corresponds to the operation in step S103 of FIG. 8, is provided in place of the operation in step S103.

The operation in step S103a of FIG. 10 is basically identical to the operation in step S103 of FIG. 8. Specifically, the cloud computer 52 prepares and determines the travel plan PN, which includes the scheduled travel route Lr, of the vehicle 30 based on the travel plan basic information acquired in step S102. In particular, the scheduled travel route Lr included in the travel plan PN determined in step S103a includes one or more toll roads. Except for this matter, the operation in step S103a of the fourth embodiment is identical to the operation in step S103 of FIG. 8.

Additionally, as compared with the flowchart of FIG. 8, an operation in step S405 is provided in the flowchart of FIG. 10 in place of the operation in step S205.

As illustrated in FIG. 10, following the operation in step S104, the determination execution unit 15 of the in-vehicle computer 32 determines whether the scheduled travel route Lr involves traveling on a toll road in step S405. For example, the determination execution unit 15 of the in-vehicle computer 32 may be configured to receive, from the navigation device ND, information indicative of the type of one or more roads included in the scheduled travel route Lr, and make this determination based on the received information.

In response to determination that the scheduled travel route Lr involves traveling on a toll road (YES in step S405), the control routine proceeds to step S206. Otherwise, in response to determination that the scheduled travel route Lr does not involve traveling on a toll road (NO in step S405), the control routine proceeds to step S207.

As described above, the in-vehicle computer 32 of the fourth embodiment is configured to execute the travel plan PN in step S206 of FIG. 10 and simultaneously execute the control routine of FIG. 6 in response to determination that the scheduled travel route Lr involves traveling on a toll road.

That is, when the vehicle 30 is scheduled to travel on a toll road, the determination unit 11 determines, in step SA01 of FIG. 6, the command value CD for controlling the motor 35, thus instructing the motor 35 to operate in accordance with the travel plan PN. Otherwise, when the vehicle 30 is not scheduled to travel on a toll road, the control routine illustrated in FIG. 6 is not executed.

That is, the in-vehicle computer 32 of the fourth embodiment is configured such that the determination unit 11 is capable of selecting (i) determining the command value CD that instructs the motor 35 to operate in accordance with the travel plan PN or (ii) not determining the command value CD in accordance with the type of a road on which the vehicle 30 is scheduled to travel, i.e., with whether the road on which the vehicle 30 is scheduled to travel is a toll road. In other words, a switching unit 11a included in the determination unit 11 is configured to switch whether the determination unit 11 determines the command value CD for controlling the motor 35 in accordance with the determination result in step S405, that is, in accordance with the type of road on which the vehicle 30 is scheduled to travel.

Because toll roads are generally maintained in good surface conditions compared with other roads and thus are subject to fewer disturbances during travel, the actual traveling state of the vehicle 30 tends to exhibit less variation.

Accordingly, switching whether to execute the control routine illustrated in FIG. 6 in accordance with the type of the road on which the vehicle 30 is scheduled to travel results in the energy consumption caused by actual traveling of the vehicle 30 being likely to be closer to the predicted energy consumption estimated when the travel plan PN was formulated.

Except for the above descriptions, the fourth embodiment is substantially identical to the second embodiment, and therefore achieves the same advantageous benefits as those achieved from the common configuration shared with the second embodiment.

### MODIFICATION OF FOURT EMBODIMENT

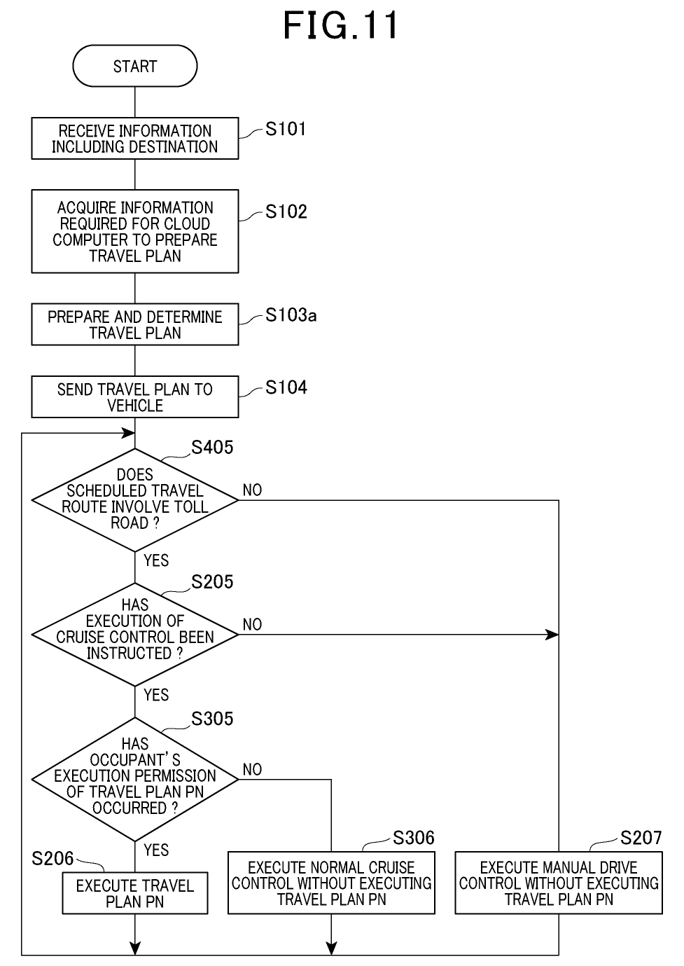

A control routine according to the fourth embodiment illustrated as the flowchart of FIG. 11 is configured such that operations in steps S205, S305, and S306 are added to the flowchart of FIG. 10. Specifically, the operations in steps S205 and S305 are inserted between the operation in step S405 and the operation in step S206.

Specifically, in response to determination that the vehicle 30 is traveling on a toll road in step S405 of FIG. 11, the control routine illustrated in FIG. 11 proceeds to step S205. The operation in each of steps S205, S305, and S306 illustrated in FIG. 11 is identical to that of the corresponding one of steps S205, S305, and S306 of FIG. 9.

### FIFTH EMBODIMENT

Next, the following describes the fifth embodiment of the present disclosure. In particular, the following mainly describes different points of the fifth embodiment, which are different from the second embodiment.

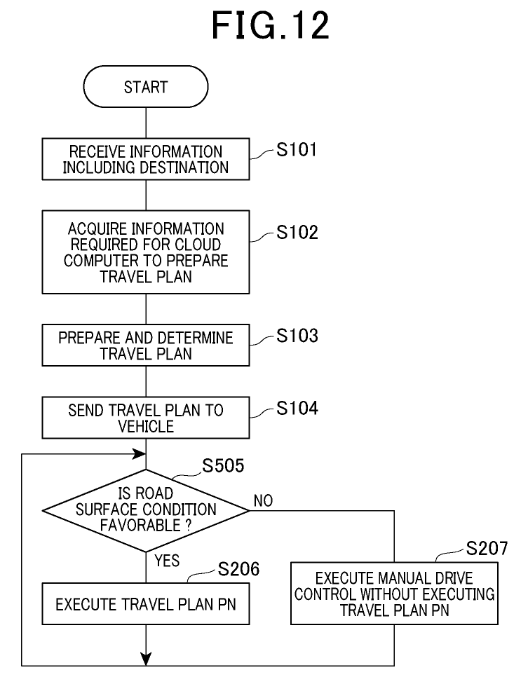

The in-vehicle computer 32 of the fifth embodiment is configured to execute a control routine illustrated in FIG. 12 in place of the control routine illustrated in FIG. 8. In FIG. 12, an operation in step S505 is provided in place of the operation in step S205.

As illustrated in FIG. 12, following the operation in step S104, the determination execution unit 15 of the in-vehicle computer 32 determines whether the surface condition of a road (i.e., road-surface condition) included in the scheduled travel route Lr on which the vehicle 30 is scheduled to travel is favorable in step S505. A favorable road-surface condition refers to a road-surface condition in which the vehicle 30 can travel while preventing slippage of the driving wheels 301 relative to the road surface. A dry road surface represents an example of such a favorable road-surface condition. In contrast, a road surface covered with puddles or an icy road surface cannot be regarded as a favorable road-surface condition and is regarded as a poor road-surface condition.

For example, the determination execution unit 15 of the in-vehicle computer 32 may be configured to receive, from an ambient temperature sensor included in the sensors VS, the ambient temperature around the vehicle 30 measured by the ambient temperature sensor, and receive, from the API service 54 of the cloud 50, weather information around the vehicle 30. Then, the determination execution unit 15 may be configured to determine whether the surface condition of the road included in the scheduled travel route Lr on which the vehicle 30 is scheduled to travel is favorable.

In this case, the determination execution unit 15 may determine that the surface condition of the road on which the vehicle 30 is scheduled to travel is favorable in response to determination that the weather for the scheduled travel route Lr based on the weather information is neither rainy nor snowy, and the ambient temperature around the scheduled travel route Lr is higher than or equal to a predetermined, experimentally set threshold for the possibility of road surface freezing; When the ambient temperature around the scheduled travel route Lr is higher than or equal to the predetermined, experimentally set threshold, there is no possibility of road surface freezing. That is, the determination execution unit 15 makes it possible to estimate that the surface condition of the road on which the vehicle 30 is traveling is a dry and unfrozen surface condition.

In response to determination that the surface condition of the road on which the vehicle 30 is scheduled to travel is favorable (YES in step S505), the control routine proceeds to step S206. Otherwise, in response to determination that the surface condition of the road on which the vehicle 30 is scheduled to travel is not favorable (NO in step S505), the control routine proceeds to step S207.

As described above, the in-vehicle computer 32 of the fifth embodiment is configured to execute the travel plan PN in step S206 of FIG. 12 and simultaneously execute the control routine of FIG. 6 in response to determination that the surface condition of the road on which the vehicle 30 is scheduled to travel is favorable.

That is, when the surface condition of the road on which the vehicle 30 is scheduled to travel is favorable, the determination unit 11 determines, in step SA01 of FIG. 6, the command value CD for controlling the motor 35, thus instructing the motor 35 to operate in accordance with the travel plan PN. Otherwise, when the surface condition of the road on which the vehicle 30 is scheduled to travel is not favorable, the control routine illustrated in FIG. 6 is not executed.

That is, the in-vehicle computer 32 of the fifth embodiment is configured such that the determination unit 11 is capable of selecting (i) determining the command value CD that instructs the motor 35 to operate in accordance with the travel plan PN or (ii) not determining the command value CD in accordance with the surface condition of the road on which the vehicle 30 is scheduled to travel. In other words, the switching unit 11a included in the determination unit 11 is configured to switch whether the determination unit 11 determines the command value CD for controlling the motor 35 in accordance with the determination result in step S505, that is, in accordance with the surface condition of the road on which the vehicle 30 is scheduled to travel.

When the surface condition of the road on which the vehicle 30 is scheduled to travel is favorable, disturbances acting on the vehicle 30 traveling on the road are smaller than in cases where the road surface condition is not favorable. This therefore results in the actual traveling conditions of the vehicle 30 being likely to be less variation.

Accordingly, switching whether to execute the control routine illustrated in FIG. 6 in accordance with the surface condition of the road on which the vehicle 30 is scheduled to travel results in the energy consumption caused by the actual traveling of the vehicle 30 being likely to be closer to the predicted energy consumption estimated when the travel plan PN was formulated.

Except for the above descriptions, the fifth embodiment is substantially identical to the second embodiment, and therefore achieves the same advantageous benefits as those achieved from the common configuration shared with the second embodiment.

### MODIFICATIONS

The vehicle 30 according to each of the above embodiments illustrated in FIG. 1 is an electric vehicle, which is an example. Specifically, the vehicle 30 may be one of a hybrid vehicle or a plug-in hybrid vehicle equipped with an internal combustion engine in addition to the motor 35 as a power source. The vehicle 30 may be an engine vehicle equipped with an internal combustion engine serving as only the power source.

If the vehicle 30 is a hybrid vehicle or a plug-in hybrid vehicle, the control target for the traveling control of the vehicle is the internal combustion engine and the motor 35. If the vehicle 30 is an engine vehicle, the control target for the traveling control of the vehicle is the internal combustion engine.

In step SA02 of FIG. 6, the independent control execution unit 12 recognizes the acceptable condition RQ determined by the independent control, and the independent control includes the safety-related control, which is an example.

For example, the independent control may include, instead of or in addition to the safety-related control, regulation-related control for causing the vehicle 30 to travel in compliance with traffic laws and regulations. This modification gives higher priority to the regulation-related control than the travel plan PN, making it possible to cause the vehicle 30 to continuously travel in accordance with the travel plan PN without preventing normal execution of the regulation-related control.

Examples of the regulation-related control include vehicle speed control that adjusts the speed of the vehicle 30 so as not to exceed a legally specified maximum speed obtained by recognizing traffic signs through image recognition or the like, and vehicle speed control that decelerates the vehicle 30 when an emergency vehicle approaches the vehicle 30 in order to yield the way.

The independent control may include, instead of or in addition to the safety-related control and the regulation-related control, protection-related control for protecting protected devices installed in the vehicle 30. This modification gives higher priority to the protection-related control than the travel plan PN, making it possible to cause the vehicle 30 to continuously travel in accordance with the travel plan PN without preventing normal execution of the protection-related control.

Examples of the protection-related control include power control for suppressing power consumption of the motor 35 or the drive inverter 36 in order to prevent overheating of the one or more protected devices, such as the motor 35, the drive inverter 36, and/or the high-voltage battery 34.

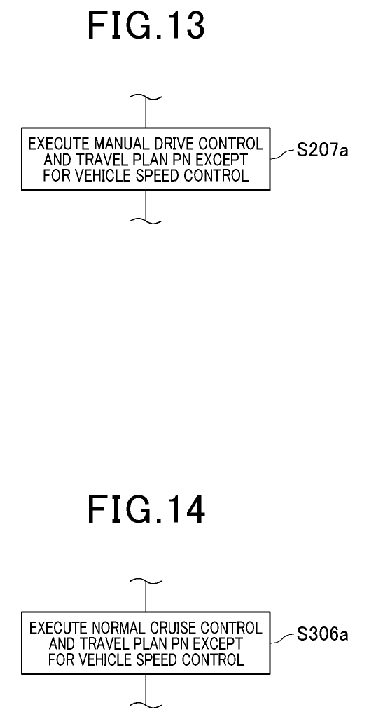

In the flowchart of FIG. 9 according to the third embodiment, the operation in step S207 may be replaced with step S207a illustrated in FIG. 13, and step S306 may be replaced with step S306a in FIG. 14.

Like the operation in step S207 of FIG. 9, the determination execution unit 15 of the in-vehicle computer 32 executes manual driving-power control. In particular, the determination execution unit 15 does not execute the vehicle speed control based on the travel plan PN, but may execute one or more control tasks based on the travel plan PN other than the vehicle speed control according to a first modification.

Specifically, as illustrated in FIG. 3, the determination execution unit 15 of the in-vehicle computation device 32 causes, in accordance with the travel plan PN, each of the target cabin temperature Trt and target battery temperature Tbt to transition with the progress of the vehicle traveling. In addition to this, the determination execution unit 15 controls the temperature control apparatus 46 so that the temperature in the cabin 30a approaches the target cabin temperature Trt included in the travel plan PN and the temperature of the high-voltage battery 34 approaches the target battery temperature Tbt included in the travel plan PN.

Like the operation in step S306 of FIG. 9, the determination execution unit 15 of the in-vehicle computer 32 executes the normal cruise control. In particular, the determination execution unit 15 does not execute the vehicle speed control based on the travel plan PN like the operation in step S207a of FIG. 13, but may execute one or more control tasks based on the travel plan PN other than the vehicle speed control according to a second modification.

As described above, the in-vehicle computation device 32 according to each of the first and second modifications causes the temperature in the cabin 30a and the temperature of the battery 34, are physical quantities other than the vehicle speed, to transition in accordance with the travel plan PN regardless of whether the control routine illustrated in FIG. 6 for the vehicle speed control based on the travel plan PN is executed.

In other words, regardless of whether a determination unit 11 determines a command value CD for controlling the motor 35 so that it operates according to the travel plan PN in step SA01 of FIG. 6, the temperature inside the cabin 30a and the battery temperature are both changed according to the travel plan PN.

Accordingly, even when the occupant 80 does not intend to delegate vehicle speed control to the vehicle 30, the in-vehicle computation device 32 according to this modification can appropriately adjust the energy consumption associated with vehicle travel by utilizing the travel plan PN.

Similarly, in the flowchart of FIG. 11, step S207 may be replaced with step S207a of FIG. 13, and step S306 may be replaced with step S306a of FIG. 14.

Furthermore, in the flowcharts of FIGS. 8, 10, and 12, step S207 may likewise be replaced with step S207a of FIG. 13.

In the above embodiments, in step SA01 of FIG. 6, the in-vehicle computation device 32 calculates motor torque as the command value CD.

However, this is merely an example.

For example, the in-vehicle computation device 32 may calculate, as the command value CD, a parameter other than motor torque, such as the amplitude or frequency of an AC voltage applied to the motor 35, as long as the parameter can be used to increase or decrease the vehicle speed.

In the fifth embodiment described above, it has been explained that, in step S505 of FIG. 12, the in-vehicle computation device 32 can determine whether the road surface condition of the road on which the vehicle 30 travels is good or not based on the outside air temperature and weather information.

However, this is merely an example.

For example, when a friction coefficient between the drive wheels 301 and the road surface is estimated by a slip traction control that suppresses slipping of the driving wheels 301, the determination as to whether the road surface condition is good may be made based on the estimated value of the friction coefficient.

In the above embodiments, the command value CD determined in the control process of FIG. 6 and output from the in-vehicle computation device 32 is a parameter for performing vehicle speed control. However, this is merely an example. The command value CD may instead be a parameter for controlling the temperature inside the cabin 30a or the battery temperature. In that case, the control target that operates according to the command value CD may be an electric compressor 38 that compresses refrigerant in a refrigeration cycle circuit, or a pump included in a water-circulation device 39. For example, the rotational speed of the electric compressor 38 or the pump may be determined as the command value CD.

Even when the command value CD is a parameter for controlling the temperature inside the cabin 30a or the battery temperature, the above-mentioned independent control that defines the acceptable condition RQ for the command value CD may include at least one of the safety-related control, the regulation-related control, and the protection-related control. Examples of the regulation-related control in this case include defogging control for suppressing fogging of windows such as the front windshield. Examples of the protection-related control in this case include output control for suppressing the output of the electric compressor 38 or the pump in order to avoid overload of the electric compressor 38 or the pump.

As shown in FIG. 3, in the above embodiments, the travel plan PN includes, as constituent elements, transitions of the target vehicle speed Vct, the target cabin temperature Trt, the target battery temperature Tbt, and the predicted SOC with the progress of the vehicle 30. However, this is merely an example. These constituent elements are not essential to the travel plan PN, and may be replaced by target values of other physical quantities or may be supplemented with additional constituent elements.

For example, transitions of a target output of retrofit load inverter 42 with the progress of the vehicle 30, or in other words, transitions of ON/OFF states of the retrofit load inverter 42, may be added to the travel plan PN of FIG. 3. The output of the retrofit load inverter 42 is also a physical quantity other than the vehicle speed that is related to the energy consumption of the vehicle 30.

In the explanation of the fourth embodiment described above, the type of road on which the vehicle 30 travels has been exemplified as whether the road is a toll road or not. This is merely an example. For instance, the road type may differ according to the number of lanes of the road.

The HMI unit 45 shown in FIG. 2 according to each of the above embodiments is provided on the instrument panel in the cabin 30a, which is merely an example.

For example, an external terminal may be connectable for data communication to the communication device 33 and the manager 51 of the cloud 50 via the wireless network NW. In this modification, one or more in-vehicle components do not constitute the HMI unit 45, and the external terminal may serve as the HMI unit 45. The external terminal may be comprised of a portable computer, such as a tablet or a smartphone, operable by the occupant 80.

The control routine illustrated in FIG. 4 is executed primarily by the cloud computer 52, i.e., by the cloud 50, which is merely an example. The control routine illustrated in FIG. 4 may be executed by, for example, an electronic control unit of the vehicle 30. The control routine illustrated in FIG. 4 may be executed by an external terminal when the external terminal is provided. The planning of a travel plan may be implemented by any of the cloud 50, the vehicle 30, and the external terminal.

The HMI unit 45 illustrated in FIG. 2 includes both the input function and output function, which is merely an example. The HMI unit 45 may be implementable with only one of the input and output functions.

The electrical configuration of the vehicle 30 and cloud 50 according to the first embodiment is illustrated in FIG. 2, which is merely an example and therefore is not limited to that illustrated in FIG. 2.

The in-vehicle computer 32 shown in FIG. 2 need not be implemented by a single computer. The in-vehicle computer 32 may be implemented by multiple computers, which are for example provided for respective functions.

The evaluation function used in step S103 of FIG. 4 to determine the various parameters of the travel plan PN is defined to increase with higher evaluation, which is merely an example. The evaluation function may be defined to decrease with higher evaluation, in which case the parameters may be determined to minimize the value of the evaluation function.

The operation in each step illustrated in the flowcharts of FIGS. 4, 6, and 8 to 12, which is implemented by one or more computer programs, may be implementable by hardware.

While the illustrative exemplary embodiments of the present disclosure have been described herein, the present disclosure is not limited to the exemplary embodiments and their configurations described herein. Specifically, the present disclosure includes various modifications and/or alternatives within the scope of the present disclosure. In addition to various combinations and forms, other combinations and forms including one or more/less elements thereof are also within the inventive principle and scope of the present disclosure.

One or more components in each of the exemplary embodiments are not necessarily essential components except for (i) one or more components that are described as one or more essential components or (ii) one or more components that are essential in principle.

Specific values disclosed in each of the exemplary embodiments, each of which represents the number of components, a physical quantity, and/or a range of a physical parameter, are not limited thereto except that (i) the specific values are obviously essential or (ii) the specific values are essential in principle.

In the exemplary embodiments, any mention of the materials, shapes, relative positions, etc., of components is not intended to be limiting, unless otherwise specified or where inherently limited by principle.

Sensors for acquiring external environmental information of the vehicle 30 (e.g., an outside air temperature) described in each of the embodiments may be omitted, and the external environmental information may instead be received from an external server of the vehicle 30 or from the cloud 50. The sensors may alternatively be omitted, and the vehicle 30 may obtain related information associated with the external environmental information from an external server or the cloud 50 and estimate the external environmental information based on the obtained related information.

The control apparatus 10 according to the present disclosure includes multiple control functional units, such as the determination unit 11, independent control execution unit 12, changing unit 13, output unit 14, and determination execution unit 15 shown in FIG. 7, which execute the operations in steps included in the flowcharts of FIGS. 4, 6, and 8 to 12. The control functional units and their methods described in the present disclosure may be implemented by a dedicated computer including a memory and a processor configured to execute one or more functions realized by one or more computer programs. The control functional units and their methods may also be implemented by a dedicated computer provided by one or more dedicated hardware logic circuits that configure the processor. The control functional units and their methods may further be implemented by a dedicated computer configured by a combination of (i) a memory and a processor programmed to execute one or more functions and (ii) a processor configured by one or more hardware logic circuits. The computer programs may be stored, as instructions to be executed by a computer, in a non-transitory tangible storage medium that is readable by the computer.

As used herein, “control circuitry” encompasses hardware implemented to perform the described functions, including one or more processors executing instructions, digital logic such as ASICs (“Application Specific Integrated Circuits”) and FPGAs (“Field Programmable Gate Arrays”), or combinations thereof. The phrase “configured to” is used to denote structure arranged to perform the recited function during operation and is not intended to invoke 35 U.S.C. §112(f) absent express “means for” language.

The control circuitry may be implemented in or as part of any one or more of a manager, a cloud computer, an in-vehicle computer, and an HMI unit. In certain embodiments, different portions of the control circuitry execute on different components and collectively implement the functions described herein.

The control circuitry may be configured to cause an appropriate portion of the control apparatus 10 to execute one or more functions as recited in each claim. Such configurations include implementations in which the control circuitry itself executes some or all of the claimed functions.

1. A control apparatus configured to control a control target included in a vehicle in accordance with a predetermined travel plan of the vehicle, the control apparatus comprising:
control circuitry configured to cause the control apparatus to:
determine a command parameter that controls the control target such that the control target operates in accordance with the travel plan;
execute, independently from the travel plan, independent control that determines an acceptable condition that defines an acceptable range of the control parameter; and
change, in response to determination that the command parameter determined by the control circuitry conflicts with the acceptable condition, the command parameter so as to satisfy the acceptable condition.

2. The control apparatus according to claim 1, wherein:
the independent control includes safety-related control configured to ensure safe travel of the vehicle;
the control target is a power source for propulsion of the vehicle installed in the vehicle; and
the control circuity is configured to cause the control apparatus to operate the power source in accordance with the determined control parameter to adjust a speed of the vehicle.

3. The control apparatus according to claim 2, wherein:
the control circuity is configured to cause the control apparatus to:
determine whether execution of cruise control that automatically controls the speed of the vehicle has been instructed by an occupant of the vehicle; and
determine the command parameter that controls the power source such that the power source operates in accordance with the travel plan in response to determination that execution of the cruise control that automatically controls the speed of the vehicle has been instructed by the occupant of the vehicle.

4. The control apparatus according to claim 2, wherein:
the safety-related control includes at least one of:
collision avoidance control configured to prevent a collision of the vehicle;
inter-vehicle distance control configured to maintains a predetermined distance between the vehicle and a preceding vehicle;
slip traction control configured to suppress slipping of one or more wheels of the vehicle; and
pre-curve deceleration control configured to decelerate the vehicle before entering a curve.

5. The control apparatus according to claim 1, wherein:
the independent control includes regulation-related control configured to cause the vehicle to travel in compliance with traffic laws and regulations;
the control target is a power source for propulsion of the vehicle installed in the vehicle; and
the control circuity is configured to cause the control apparatus to operate the power source in accordance with the determined control parameter to adjust a speed of the vehicle.

6. The control apparatus according to claim 1, wherein:
the travel plan is a plan that causes (i) a speed of the vehicle and (ii) one or more other physical quantities other than the speed of the vehicle to transition in accordance with the travel plan;
the control target is a power source for propulsion of the vehicle installed in the vehicle; and
the control circuity is configured to cause the control apparatus to:
operate the power source in accordance with the determined control parameter to adjust the speed of the vehicle;
switch whether to determine the command parameter that controls the power source such that the power source operates in accordance with the determined control parameter; and
cause the one or more other physical quantities to transition in accordance with the travel plan independently of whether to determine the command parameter that controls the power source such that the power source operates in accordance with the determined control parameter.

7. The control apparatus according to claim 2, wherein:
the control circuity is configured to cause the control apparatus to determine the command parameter that controls the power source such that the power source operates in accordance with the travel plan in response to determination that a predetermined manual operation of an interface unit connected to the control apparatus has occurred by an occupant of the vehicle.

8. The control apparatus according to claim 2, wherein:
the control circuity is configured to cause the control apparatus to switch whether to determine the command parameter in accordance with a type of a road on which the vehicle is scheduled to travel.

9. The control apparatus according to claim 2, wherein:
the control circuity is configured to cause the control apparatus to switch whether to determine the command parameter in accordance with a surface condition of a road on which the vehicle is scheduled to travel.

10. The control apparatus according to claim 1, wherein:
the independent control include protection-related control for protecting one or more protected devices installed in the vehicle.

11. A program product for controlling a control target included in a vehicle in accordance with a predetermined travel plan of the vehicle, the program product comprising:
a non-transitory storage medium; and
computer-program instructions stored in the non-transitory storage medium,
the computer-program instructions causing a processor to:
determine a command parameter that controls the control target such that the control target operates in accordance with the travel plan;
execute, independently from the travel plan, independent control that determines an acceptable condition that defines an acceptable range of the control parameter; and
change, in response to determination that the command parameter determined by the control circuitry conflicts with the acceptable condition, the command parameter so as to satisfy the acceptable condition.

12. A method of controlling a control target included in a vehicle in accordance with a predetermined travel plan of the vehicle, the method comprising:
determining a command parameter that controls the control target such that the control target operates in accordance with the travel plan;
executing, independently from the travel plan, independent control that determines an acceptable condition that defines an acceptable range of the control parameter; and
changing, in response to determination that the command parameter determined by the control circuitry conflicts with the acceptable condition, the command parameter so as to satisfy the acceptable condition.
